(19) United States
(12) Patent Application Publication
(10) Pub. No.: US 2003/0217460 A1
(43) Pub. Date: Nov. 27, 2003

(54) Semiconductor manufacturing apparatus

(75) Inventor: Shinichi Nishiura, Fussa-Shi (JP)

Correspondence Address: Koda & Androlia, 2029 Century Park East, Suite 1430, Los Angeles, CA, 90067, US

(73) Assignee: Kabushiki Kaisha Shinkawa

(21) Appl. No.: 10/444,367

(22) Filed: May 23, 2003

(30) Foreign Application Priority Data
May 24, 2002 (JP) 2002-150193

(51) Int. Cl. B23Q 15/00

(52) U.S. Cl. 29/705

(57) ABSTRACT

A semiconductor manufacturing apparatus including a wafer stage that carries a semiconductor wafer. The wafer stage is formed at its wafer carrying surface with a porous metal portion, thus allowing the attractive force arising from the Coulomb force between the wafer and wafer stage to be reduced and avoiding sticking of the wafer to the wafer stage.

### BACKGROUND OF THE INVENTION

1. Field of the Invention

The present invention relates to a semiconductor manufacturing apparatus and more particularly relates to a semiconductor manufacturing apparatus that provides an improved handling characteristics of semiconductor wafers on a wafer stage.

2. Prior Art

In semiconductor device manufacturing processes, semiconductor wafers (merely called “wafers”) are placed on the flat carrying surface of a wafer stage and are subjected to specified positioning. Afterward, the wafers are held by vacuum suction if necessary, and the wafers on the wafer stage are heated and subjected to bump bonding. Subsequently, the wafers are removed from the wafer stage using a jig.

Conventional wafer stages include a metal material, and through-holes which run through the wafer stage in the vertical direction are formed in such wafer stages. Suction is applied by a pump via these through-holes, thus temporarily fixing the wafers in place so that the wafers do not move (see, for example, Japanese Patent Application laid-Open (Kokai) No. H07-22355).

However, the undersurfaces of the wafers have a high degree of flatness, and static electricity (mainly a “+ charge”) is often generated on the surfaces of the wafers by the charge that accumulates in the wafers at high temperatures. In such cases, the wafers may become strongly stuck to the wafer stage by the Coulomb force that is generated between the wafers and the wafer stage, which is at the ground potential. This phenomenon is especially conspicuous in cases in which the wafers have a property of accumulating a charge when exposed to heat, such as, for instance, SAW (Surface Acoustic Wave) filter wafers made of lithium tantalate, etc.

If an attempt is made to remove such wafers forcibly by means of a jig, there is a danger that the wafers will be damaged. Furthermore, if the removal of the wafers is delayed until the wafers have cooled, there is a conspicuous drop in productivity.

### SUMMARY OF THE INVENTION

Accordingly, the object of the present invention is to improve the handling characteristics of wafers in the wafer stage.

The above object is accomplished by a unique structure for a semiconductor wafer manufacturing apparatus of the present invention in which a porous metal portion is disposed on at least a part of the carrying surface of a wafer stage on which a semiconductor wafer is placed.

Since the porous metal portion is disposed on at least a part of the carrying surface of the wafer stage, sticking of the wafer caused by the Coulomb force can be suppressed as a result of a reduction in the contact area between the semiconductor wafer and the wafer stage.

Furthermore, in the above structure, the porous metal portion possesses air permeability, and the manufacturing apparatus is further equipped with a low-pressure source which acts on the semiconductor wafer via the porous metal portion.

Since a low-pressure source acts on the semiconductor wafer via the porous metal portion, the wafer is caused to adhere to the carrying surface by vacuum suction, and a positional deviation of the wafer can be suppressed.

In the present invention, the above-described porous metal portion possesses air permeability, and the manufacturing apparatus is further equipped with a high-pressure source which acts on the semiconductor wafer via the porous metal portion.

Since a high-pressure source acts on the semiconductor wafer via the porous metal portion, the removal of the wafer from the carrying surface is promoted, and the removal of the wafer after intended treatment thereon is quickly accomplished.

It is preferable that the porous metal portion in the present invention be a foam metal or a sintered metal. In cases where the porous metal portion is a foam metal, it is especially preferable that the porosity of the porous metal portion be 30 percent or greater.

### BRIEF DESCRIPTION OF THE DRAWINGS

FIG. 1 is a sectional view of the wafer stage in the embodiment of the present invention; and

FIG. 2 is a perspective view of the wafer stage.

### DETAILED DESCRIPTION OF THE INVENTION

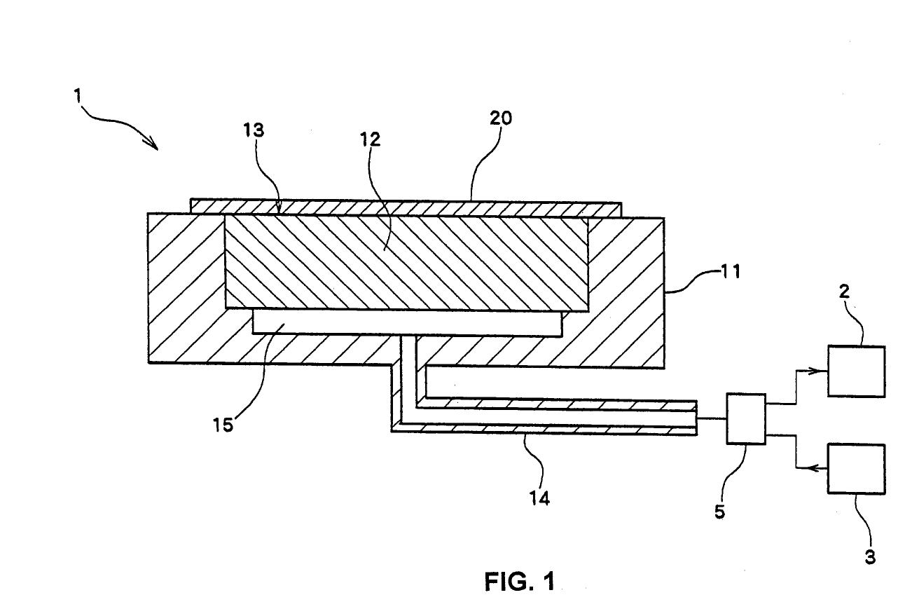

Embodiments of the present invention will be described below with reference to the accompanying drawings. In FIG. 1, a flip-chip bump bonding apparatus of the shown embodiment is comprised of a wafer stage 1, an exhaust pump 2, and an air compressor 3.

The wafer stage 1 includes a stage frame 11 and a porous metal portion 12. The upper surfaces of the stage frame 11 and porous metal portion 12 are worked to smooth surfaces at equal heights so as to be flush, thus forming a carrying surface 13. An air passage pipe 14 is formed in the bottom surface of the stage frame 11, and this air passage pipe 14 communicates with a hollow chamber 15 inside the stage frame 11. The stage frame 11 is constructed from stainless steel. Furthermore, the stage frame 11 contains a heater (not shown) and is grounded by ground wiring (not shown).

The porous metal portion 12 is a foam metal material and is constructed from a continuously foamed porous steel material so that air can pass through. The porous metal portion 12 has a finely branched structure, and pores with a diameter of, for instance, 500 μm or less are uniformly distributed throughout the entire porous metal portion in both the surface and interior. In order to ensure sufficient conductivity and strength, it is preferable to use an ultra-hard alloy or ultra-hard metal as the material of the porous metal portion 12. The porosity of the porous metal portion 12 can be set as desired; however, in order to prevent sticking of the wafer by reducing the contact area between the porous metal portion 12 and the semiconductor wafer, it is especially preferable that the porosity be set at, for example, 30 percent or greater.

A switching valve 5 is connected to the air passage pipe 14 by air pressure piping. The switching valve 5 selectively connects the air passage pipe 14 to either the exhaust pump 2 or the air compressor 3; for example, it is preferable to use a known three-port two-position valve and an electromagnetic solenoid for this switching valve 5.

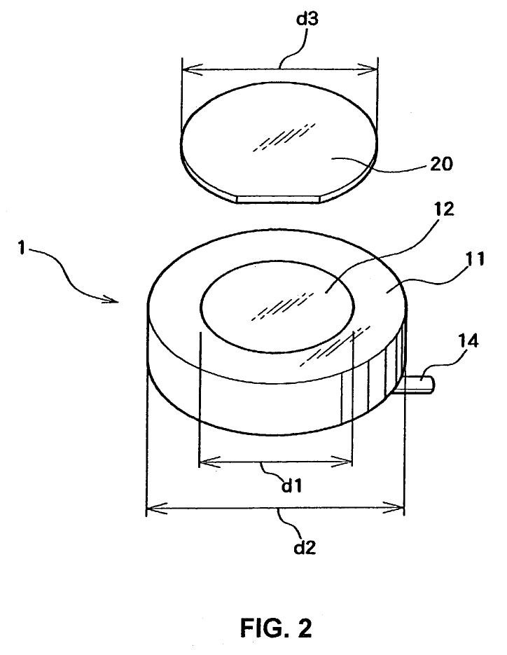

As shown in FIG. 2, the upper surfaces of the stage frame 11 and porous metal portion 12 are both substantially circular; furthermore, the diameter d1 of the upper surface of the porous metal portion 12 is smaller than the diameter d3 of the wafer 20, and the diameter d2 of the stage frame 11 is larger than the diameter d3 of the wafer 20. As a result, the wafer 20 carried on the wafer stage 1 covers the entire upper surface of the porous metal portion 12.

In the above construction, a wafer 20 such as an SAW device wafer, etc. is placed on the carrying surface 13 of the wafer stage 1. Next, the exhaust pump 2 in an operating state is caused to communicate with the air passage pipe 14 by the switching valve 5, so that the wafer 20 is temporarily fastened to the carrying surface 13.

In this state, the wafer 20 is heated by a heater, and bonding work is performed. Here, as the temperature of the wafer 20 rises, the electric field strength in the vicinity of the undersurface of the wafer 20 increases as a result of polarization of the wafer 20. However, since the Coulomb force between the wafer 20 and the wafer stage 1 is proportional to the contact area between the two parts, and since the porous metal portion 12 is disposed on the carrying surface 13 in the shown embodiment, the attractive force arising from the Coulomb force between the wafer 20 and the wafer stage 1 is conspicuously smaller than in the case of the above-described prior art as a result of a reduction in the contact area between the wafer 20 and the wafer stage 1.

Following the completion of the bonding work, the air compressor 3 in an operating state is caused to communicate with the air passage pipe 14 by the switching valve 5, and the air pressure on the side of the undersurface of the wafer 20 slightly exceeds atmospheric pressure. Thus, the wafer 20 can be removed easily from the carrying surface 13.

As seen from the above, in the shown embodiment, since the porous metal portion 12 is disposed on at least a part of the carrying surface 13 of the wafer stage 1, the contact area between the wafer 20 and the wafer stage 1 is small, and thus the sticking of the wafer 20 caused by the Coulomb force can be suppressed.

Furthermore, since the exhaust pump 2 is used as a low-pressure source (which is a means for reducing the pressure so that the air pressure on the side of the undersurface of the wafer 20 becomes lower than the air pressure on the side of the upper surface) and is caused to act on the wafer 20 via the porous metal portion 12, the wafer 20 is caused to adhere to the carrying surface 13 by vacuum suction, and the positional deviation of the wafer 20 is suppressed.

In addition, since the air compressor 3 is used as a high-pressure source (which is a means for increasing the pressure so that the air pressure on the side of the undersurface of the wafer 20 is higher than the air pressure on the side of the upper surface) and is caused to act on the wafer 20 via the porous metal portion 12, the wafer 20 is promoted to be removed easily from the carrying surface 13, and the removal of the wafer 20, which is done after the intended treatment is performed on the water, can be quickly accomplished.

In the shown embodiment, a continuously foamed metal material possessing air permeability is used as the material of the porous metal portion 12. However, a material with independent bubbles can be used as the material of the porous metal portion; and in this case as well, sticking can be suppressed since the contact area between the wafer and the carrying surface is reduced.

Furthermore, in the shown embodiment, a steel material is used as the material of the porous metal portion 12. However, some other material can be used as the material of the porous metal portion, as long as this material has sufficient conductivity and strength.

Furthermore, a foam metal is used as the material of the porous metal portion 12 in the shown embodiment. However, a sintered metal (or a powder-forged metal product) can be also used as the material of the porous metal portion 12. In this case, since the porosity of the sintered metal is ordinarily low, i.e., approximately 5 to 25%, the effect in suppressing sticking of the wafer by reducing the contact area between the wafer and the carrying surface is correspondingly diminished, but a wafer stage that has ample strength and durability can be obtained. Furthermore, it is preferable that the powder particle diameter of the sintered metal be approximately 20 to 50 μm. Such a diameter can be outside this range.

Furthermore, in the shown embodiment, the air pressure on the side of the undersurface of the wafer is slightly higher than atmospheric pressure by the discharge air from the air compressor 3. Accordingly, the attractive force between the wafer 20 and the wafer stage 1 and the buoyancy of the wafer 20 caused by this air pressure is balanced, or the latter can be set higher than former. It is also possible to set the pressure on the undersurface side of the wafer 20, which is generated by the action of the air compressor 3, to be equal to atmospheric pressure, thus facilitating or accelerating the removal of the wafer 20 to this extent. Moreover, in the shown embodiment, both the suction of air and the discharge of air are performed via the porous metal portion 12; however, it is also possible to take a structure in which either one of the air suction or the air discharge is performed.

Furthermore, in the shown embodiment, the upper surface of the porous metal portion 12 contacts substantially the entire surface of the wafer 20. In the present invention, however, it is also possible for the upper surface of the porous metal portion 12 to contact only a part of the wafer 20; and the intended effect of the present invention which is to suppress the sticking of the wafer and the carrying surface by way of reducing the contact area between these two elements.

Though the porous metal portion 12 is a single block, the porous metal portion used in the present invention can be in a form of a plurality of block elements. Furthermore, it can be possible to take a construction in which the supply and discharge of air are performed via only some of the blocks among such plurality of block element.

Furthermore, in the shown embodiment, the present invention is described with reference to a flip-chip bonding apparatus. However, the present invention is widely applicable to other types of bonding apparatuses and to various types of semiconductor manufacturing apparatuses in which wafers are temporarily held.

1. A semiconductor manufacturing apparatus wherein a porous metal portion is disposed on at least a part of a carrying surface of a wafer stage on which a semiconductor wafer is placed.

2. The semiconductor manufacturing apparatus according to claim 1, wherein said porous metal portion possesses air permeability, and said manufacturing apparatus is provided with a low-pressure source which acts on said semiconductor wafer via said porous metal portion.

3. The semiconductor manufacturing apparatus according to claim 1 or 2, wherein said porous metal portion possesses air permeability, and said manufacturing apparatus is provided with a high-pressure source which acts on said semiconductor wafer via said porous metal portion.

4. The semiconductor manufacturing apparatus according to claim 1 or 2, wherein said porous metal portion is a foam metal.

5. The semiconductor manufacturing apparatus according to claim 3, wherein said porous metal portion is a foam metal.

6. The semiconductor manufacturing apparatus according to claim 4, wherein a porosity of said foam metal is 30 percent or greater.

7. The semiconductor manufacturing apparatus according to claim 5, wherein a porosity of said foam metal is 30 percent or greater.

8. The semiconductor manufacturing apparatus according to claim 1 or 2, wherein said porous metal portion is a sintered metal.

9. The semiconductor manufacturing apparatus according to claim 3, wherein said porous metal portion is a sintered metal.
